(19) United States
(12) Patent Application Publication
(10) Pub. No.: US 2015/0044013 A1
(43) Pub. Date: Feb. 12, 2015

(54) MAGNETIC RETRIEVAL TOOL

(71) Applicant: ROHRBACK COSASCO SYSTEMS, INC., Santa Fe Springs, CA (US)

(72) Inventor: Allan John Perkins, Santa Fe Springs, CA (US)

(21) Appl. No.: 14/521,410

(22) Filed: Oct. 22, 2014

Related U.S. Application Data
(63) Continuation of application No. PCT/US2013/038507, filed on Apr. 26, 2013.
(60) Provisional application No. 61/639,807, filed on Apr. 27, 2012.
(60) Provisional application No. 61/640,861, filed on May 1, 2012.

(51) Int. Cl. B25J 15/06; B25J 11/00

(52) U.S. Cl. CPC B25J 15/0608; B25J 11/00
USPC 414/800; 294/65.5

(57) ABSTRACT

A magnetic retrieval tool for retrieving devices, such as probes, from a pressurized system. The retrieval tool uses a magnetic coupling to transfer movement of an external mechanism (i.e. external to the pressurized system), such as by an operator's manual movement, a motor or other drive, to an internal mechanism (i.e. internal to the pressurized system). The magnetic coupling may be through a wall of a pressure vessel using an outer magnetic core coupled to the outside of the pressure vessel which magnetically couples to an inner magnetic core disposed on the inside of the pressure vessel, such that translational or rotational movement of the outer magnetic core cause substantially simultaneous and corresponding translational and/or rotational movement of the inner magnetic core. An end effector tool is coupled to the inner magnetic core to engage and retrieve or insert the device into the pressurized system.

### CROSS-REFERENCE TO RELATED APPLICATIONS

This application is a continuation of PCT/US2013/038507, filed Apr. 26, 2013, which claims the benefit of U.S. provisional Application No. 61/639,807, filed on Apr. 27, 2012, and U.S. provisional Application No. 61/640,861, filed May 1, 2012. Priority to the aforementioned application is hereby expressly claimed in accordance with 35 U.S.C. §§119, 120, 365 and 371 and any other applicable laws. The contents of the aforementioned application(s) are hereby incorporated herein by reference in their entirety as if set forth fully herein.

### BACKGROUND

The field of the invention generally relates to retrieval tools such as those used in the oil, gas and chemical process industries, and more specifically to retrieval tools for retrieving items and devices in a pressurized system without releasing the system pressure.

In a number of applications it is desirable, or necessary, to be able to insert items and devices into a system of pipes or vessels under pressure without releasing the system pressure and/or having to shut down the system. This may be required because the system is too expensive to shut down, or for other convenience or safety reasons.

Special retrieval tools are used for this purpose, and are generally utilized in the oil and gas, and other chemical process industries. Typically, the retrieval tools are used to insert and remove devices such as metal corrosion coupons, mechanical and electronic monitoring probes, chemical injection nozzles, and the like, installed inside pipes and vessels under pressure while the plant or system is still operating. These retrieval devices are typically used in conjunction with a special access fitting, such as a COSASCO® fitting, and a separate isolating service valve which contains system pressure while the probe or device is being inserted into, or removed from, the system.

These retrieval devices typically contain system pressure and allow manipulation of the internal mechanisms of the pressurized access fitting that is under pressure by an operator on the outside of the pressure barrier. Many retrievers use mechanical coupling mechanisms and mechanical seals to connect from the internal pressurized operated parts of the retriever to the external parts manipulated by the operator, to provide both translational and rotational control. Other retrievers use hydraulic systems to control the internal parts from the outside, typically where only a translational motion is required.

A typical access fitting assembly 10 is shown in FIG. 1. The access fitting assembly 10 comprises an access fitting 12 which is mounted on the pipe 14 or vessel, usually with a welded, flanged or other high pressure coupling. The devices, such as an electronic probe 16 or mechanical probe 18, to be inserted inside the pipe 14 through the access fitting 12 are sealed to an access plug 22 which seals to access fitting body 12, so that once in place there is no isolating valve. The retriever and service valve then allow the inserted devices 16 or 18 to be removed and installed without shutting down the system operation and pressurization.

Some typical prior mechanical configuration retrievers 26 and 28 are shown in FIG. 2 and FIG. 3, respectively. The typical sequence of operations for use of both retrievers 26, 28 in FIG. 2 and FIG. 3, respectfully, is as follows:

First, as shown in diagram 1 of FIGS. 2 and 3, a protection plug 24 is removed from access plug 22 and a service valve 30 is attached to the access fitting 12. The service valve 30 is open at this point to allow access to the plug 22 in the access fitting 12. As shown in diagram 2, the retriever 26, 28 is attached to the service valve 30 or directly to the access fitting.

Also shown in diagram 2, the retriever 26, 28 is manipulated to longitudinally move the end effector tool 32 of the retriever 26, 28 to engage the plug 22 in the access fitting 12.

Further shown in step 2, the retriever 26, 28 is then manipulated to rotate the end effector tool 32 to unscrew the plug 22.

As the plug 22 is removed, the system pressure within the pipe 14 passes the plug 22 with device 16 or 18 and pressurizes the internal chamber of the retriever 26, 28. The retriever 26, 28 is further manipulated to rotate the end effector tool 32 to completely unscrew the plug 22 with device 16 or 18 from the access fitting 12.

Next, as shown in Diagram 3, the retriever 26, 28 is manipulated to longitudinally retract the end effector tool 32, the plug 22 with device 16 or 18 being removed from the pipe 14. Also, the service valve 30 is closed to seal the pressure within the pipe 14 and at the same time isolate the retriever from the pressurized pipe 14. The retriever 26, 28 is then de-pressurized and removed from the access fitting 12.

The plug 22 and device 16 or 18 may then be removed from the retriever 26, 28, as shown in diagram 4.

The procedure is simply reversed in order to insert/install the plug 22 and device 16 or 18 into the pipe 14.

However, the sliding seals of the retriever in FIG. 2 and the rotary seals and thrust bearings of the retriever in FIG. 3 become a system pressure limitation. With dirty process conditions such as sand and debris, damage can be caused to the seals with consequential operational failure.

### SUMMARY

The present invention is directed to an innovative magnetic retrieval tool which uses a magnetic coupling to transfer movement of an external mechanism (i.e. external to the pressurized system), such as by an operator's manual movement, a motor or other drive, to an internal mechanism (i.e. internal to the pressurized system). For example, the magnetic coupling may be through a wall of a pressure vessel using one fixed magnetic configuration outside the pressure vessel which magnetically couples to a second fixed magnetic configuration inside the pressure vessel. This magnetic coupling removes the need for the mechanical seals required on existing mechanical coupled retrievers because there is no direct physical contact between the external mechanism and the internal mechanism, as with all mechanical configuration retrieval tools such as those described above with respect to FIGS. 2 and 3. Thus, the internal mechanism can be completely sealed within the pressure vessel with no structure such as a shaft, or even electrical wires, extending from the internal mechanism to outside the pressure vessel.

In one embodiment, the magnetic retrieval tool comprises a pressure vessel having a vessel wall having a top and a bottom, a sealed top end at the top of the vessel wall and an open bottom end at the bottom of the vessel wall. The pressure vessel has a longitudinal axis extending from the top end to the bottom end. For instance, the pressure vessel may be an elongated cylindrical tube having a tube wall, a cap on the top end and an opening at the bottom end. The pressure vessel has an outer portion outside the vessel wall and an inner portion inside the vessel wall.

The magnetic retrieval tool has an outer drive assembly mounted to the outer portion of the pressure vessel in a manner to allow movement of the outer drive assembly longitudinally along the longitudinal axis of the pressure vessel, and rotationally about the longitudinal axis of the pressure vessel. The outer drive assembly has an outer magnetic core mounted within a sleeve. The outer magnetic core comprises at least one outer core magnet(s) each having a magnetic pole(s) adjacent the vessel wall. The sleeve is coupled to an actuation mechanism, such as a handle or other drive system.

An inner rotor is disposed within the inner portion of the pressure vessel, and is magnetically coupled to the outer drive assembly in a manner such that movement of the outer drive assembly causes substantially simultaneous and corresponding movement of the inner rotor. For instance, the inner rotor is positioned adjacent the outer drive assembly on the opposite side of the vessel wall. The inner rotor comprises an inner magnetic core mounted to a support core. The inner magnetic core comprises at least one inner core magnet(s) each having a magnetic pole(s) adjacent the vessel wall and substantially oppositely aligned with the magnetic pole(s) of the outer core magnet(s). The term “substantially oppositely aligned” means that the pole(s) of the outer core magnet(s) and the pole(s) of the inner core magnet(s) are positioned relative to one another to produce a significant coupling force (rotational torque and/or translational force) between the outer magnetic core and the inner magnetic core such that movement of the outer drive assembly causes substantially simultaneous and corresponding movement of the inner rotor. In this way, the magnetic field of the inner core magnet(s) and the magnetic field of the outer core magnet(s) create forces pulling together the opposing inner core magnet(s) and the outer core magnet(s).

The inner core also has an end effector tool for engaging and manipulating an access plug and/or device (such as a probe) within the pressurized system. As an example, the end effector tool may comprise a wrench head for engaging a square or hex head of an access plug.

In another aspect, the outer magnetic core may comprise a plurality of magnets having alternating magnetic poles adjacent to the vessel wall. In this configuration, the inner magnetic core also comprises a plurality of magnets having alternating magnetic poles adjacent the vessel wall, with the magnetic poles of the inner magnetic core oppositely aligned with the alternating magnetic poles of the outer magnetic core.

In still another aspect, the outer magnetic core may comprise a plurality of magnets having all similar magnetic poles adjacent to the vessel wall. In this configuration, the inner magnetic core also comprises a plurality of magnets having all similar poles adjacent the vessel wall, with the magnetic poles of the inner magnetic core substantially oppositely aligned with the magnetic poles of the outer magnetic core.

The operation and use of the magnetic retrieval tool to retrieve or insert a device into a pressurized system, without depressurizing the system, is fairly straightforward. The use of the magnetic retrieval tool to retrieve a device, such as a probe, from a pressurized system will be described first. In the typical situation, the device is installed behind an access plug of an access fitting mounted on a pipe or vessel of the pressurized system. If the access fitting is not already fitted with a service valve, then a service valve is first installed onto the access fitting providing a pressure tight seal between the access fitting and the service valve. The service valve is open at this point, as the system pressure is sealed by the access plug.

Then, the magnetic retrieval tool is installed on the service valve, providing a pressure tight seal between the service valve and the magnetic retrieval tool. The outer drive assembly is actuated, such as by manually manipulating a handle or operating a driver, to move the outer magnetic core longitudinally proximally toward the access plug. The longitudinal movement of the outer magnetic core causes substantially simultaneous and corresponding longitudinal movement of the inner rotor and its inner magnetic core to move the end effector tool of the inner rotor through the service valve and into engagement with the access plug.

The outer drive assembly is then manipulated to remove the plug from the access fitting. For instance, the outer drive assembly may be actuated to rotate the outer magnetic core about the longitudinal axis of the pressure vessel. The rotational movement of the outer magnetic core causes substantially simultaneous and corresponding rotation of the inner rotor and its inner magnetic core to rotate the end effector tool of the inner rotor. The rotation of the end effector tool unscrews the access plug from the access fitting. As the plug is partially unscrewed, the plug allows system pressure to pass the plug and pressurize the pressure vessel of the magnetic retrieval tool.

Once the pressure vessel is pressurized, the outer drive assembly is manipulated to completely remove the plug and also the device (such as a probe) behind the plug. This may entail further rotation of the outer drive assembly, which drives the inner rotor and end effector tool. Once the plug and device are completely detached from the access fitting, the outer drive assembly is manipulated to move the outer magnetic core longitudinally distally away from the access fitting. The longitudinal movement of the outer magnetic core causes substantially simultaneous and corresponding longitudinal movement of the inner rotor and its inner magnetic core to move the end effector tool, plug and device out through the service valve and into the pressure vessel of the magnetic retrieval tool.

The service valve is then shut to seal the system process pressure from the magnetic retrieval tool. The pressure vessel is de-pressurized. The magnetic retrieval tool is removed from the service valve. Finally, the access plug, and attached device may be removed from the end effector tool of the inner rotor.

The procedure for using the magnetic retrieval tool to insert a device, such as a probe, into a pressurized system is basically the reverse order of the procedure to retrieve a device. The device is attached to the access plug. The access plug and attached device are coupled to the end effector tool of the magnetic retrieval device. If not already in place, a service valve is installed onto the access fitting providing a pressure tight seal between the access fitting and the service valve. If a plug is installed on the access fitting, then it is first removed using the magnetic retrieval tool, as described above.

With the plug removed, and the service valve installed with the service valve closed at this point, the magnetic retrieval tool is installed on the service valve, providing a pressure tight seal between the service valve and the magnetic retrieval tool. A bypass valve on the service valve is opened to slowly pressurize the pressure vessel to the system pressure.

The service valve is then opened, such as fully opened, to allow the device and plug to be inserted through the service valve to the access fitting. The outer drive assembly is actuated to move the outer magnetic core longitudinally proximally toward the access fitting. The longitudinal movement of the outer magnetic core causes substantially simultaneous and corresponding longitudinal movement of the inner rotor and its inner magnetic core to move the end effector tool, plug and attached device through the service valve to the access fitting.

The outer drive assembly is then manipulated to engage the access plug and device into the access fitting. Similar to the removal step described above, except in the opposite direction, the outer drive assembly may be actuated to rotate the outer magnetic core about the longitudinal axis of the pressure vessel. The rotational movement of the outer magnetic core causes substantially simultaneous and corresponding rotation of the inner rotor and its inner magnetic core to rotate the end effector tool of the inner rotor. The rotation of the end effector tool screws the access plug into the access fitting. The outer drive assembly is manipulated to tighten the access plug and device sufficiently to provide a seal of the system pressure.

The pressure vessel is slowly de-pressurized, and then is removed from the service valve. The service valve may then be removed from the access fitting.

### BRIEF DESCRIPTION OF THE DRAWINGS

FIG. 1 is a side perspective, exploded view of a typical access fitting assembly installed on a pressurized system pipe.

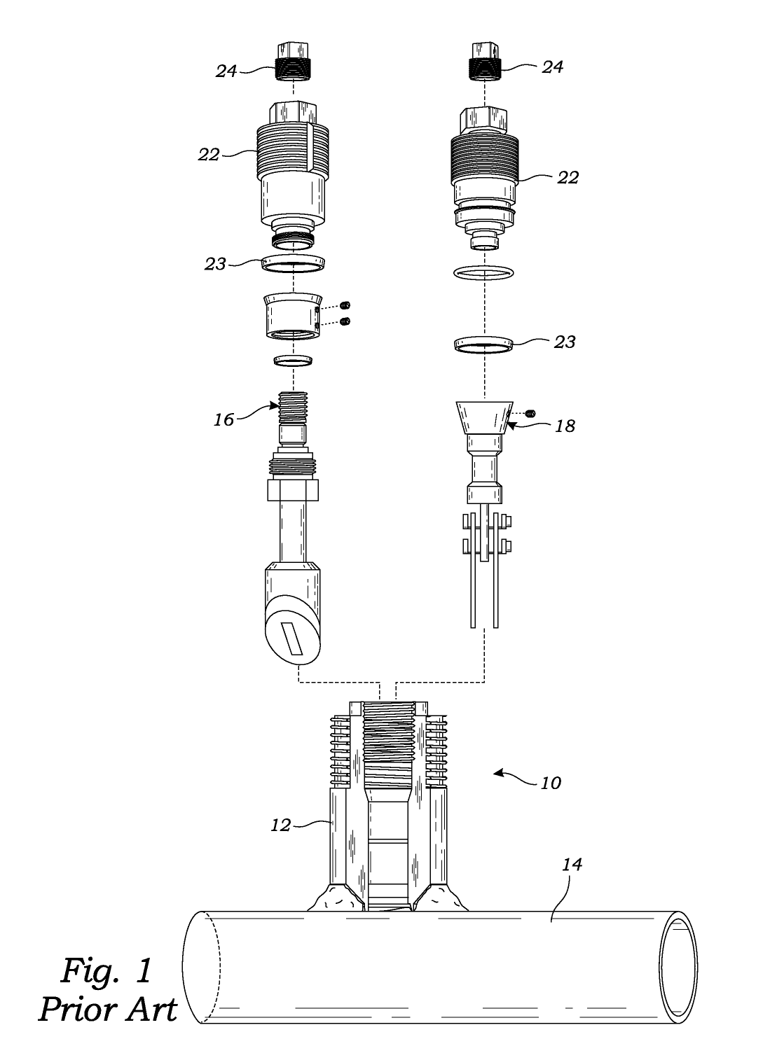

FIG. 2 is a side, perspective view of a mechanical configuration retriever having sliding seals and showing the sequence of operations for use of the retriever to retrieve a device from a pressurized system.

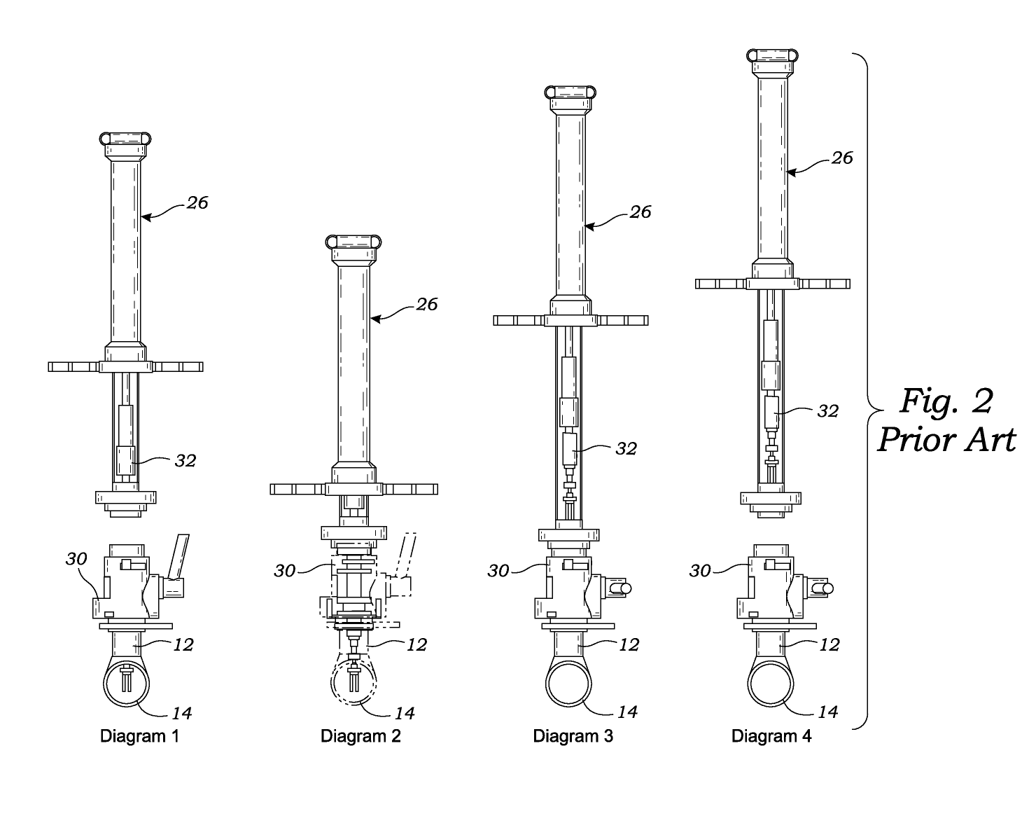

FIG. 3 is a side, perspective view of a mechanical configuration retriever having rotary seals and showing the sequence of operations for use of the retriever to retrieve a device from a pressurized system.

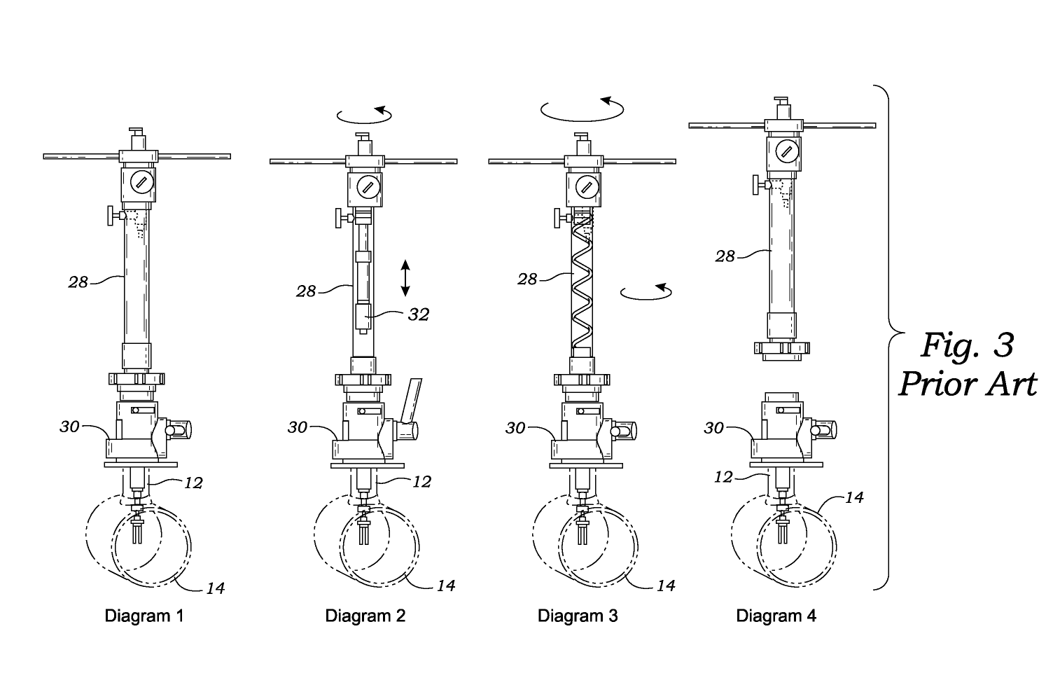

FIG. 4 is a side, perspective view of a magnetic retrieval tool according to one embodiment of the present invention.

FIG. 5 is a side, perspective view of the magnetic retrieval tool of FIG. 4 showing exemplary dimensions.

FIG. 6 is a partial, enlarged, side, perspective view of the magnetic retrieval tool of FIG. 4.

FIG. 7 is a partial, enlarged, side, cut-away perspective view of the magnetic retrieval tool of FIG. 4.

FIG. 8 is a table of magnetic force calculations for an 8-segment alternating magnet outer magnetic core and inner magnetic core configuration having an axial length of 4 inches and having the listed specifications.

FIG. 9 is a cross-sectional dimensional schematic of the outer magnetic core and inner magnetic core configuration for the table of FIG. 8.

FIG. 10 is a table of torque and axial force for the outer magnetic core and inner magnetic core configuration of FIG. 8 for different rotational slip angles (offset) between the outer magnetic core and inner magnetic core.

FIG. 11 is a magnetic fluxplot of an 8-segment outer magnetic core and inner magnetic core, thin-wall, configuration with 20 degrees radial offset between the outer magnetic core and inner magnetic core.

FIG. 12 is a magnetic fluxplot of an 8-segment outer magnetic core and inner magnetic core, thick-wall, configuration with 20 degrees radial offset between the outer magnetic core and inner magnetic core, and a 6.00 inches outer diameter.

FIG. 13 is a magnetic fluxplot of an 8-segment outer magnetic core and inner magnetic core, thin-wall, configuration with 20 degrees radial offset between the outer magnetic core and inner magnetic core, and a 5.50 inches outer diameter.

### DETAILED DESCRIPTION

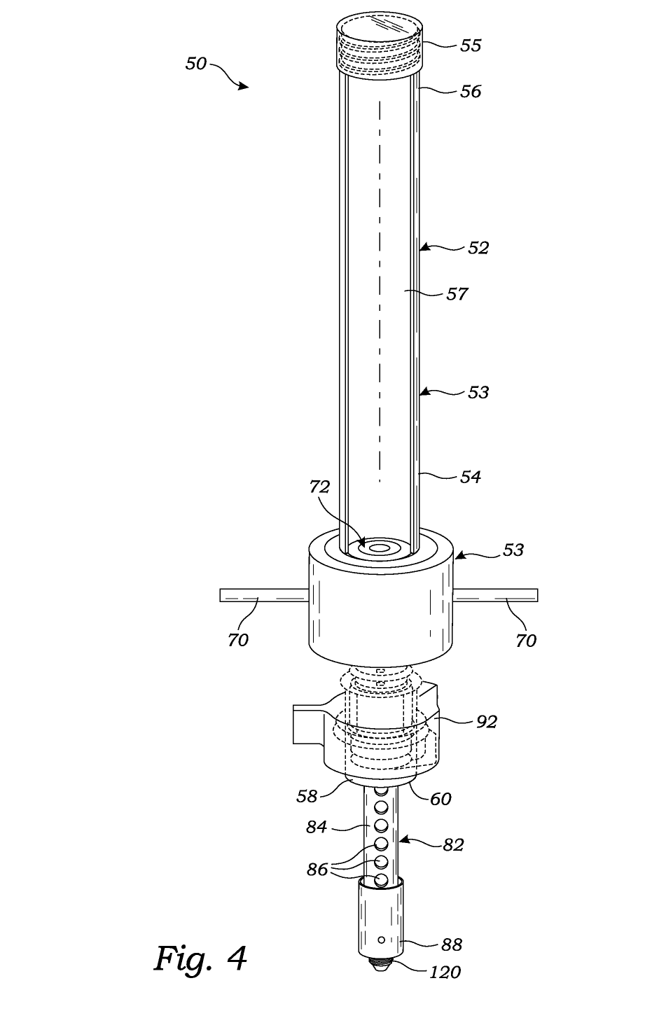

Referring to FIGS. 4-7, one embodiment of a magnetic retrieval tool 50 according to the present invention is shown. The magnetic retrieval tool 50 comprises a main pressure vessel 52. The pressure vessel 52 in this embodiment comprises an elongated cylindrical tube 53 having a tube wall 54, a top end 56 and a bottom end 58. The pressure vessel 52 also has a cap 55 on the top end 56 of the tube 53 sealing the top end 56 of the tube 53. The bottom end 58 of the tube 53 has an opening 60. The tube 53 defines a longitudinal axis 57 through the center of the circular cross-section of the tube 53. The tube 53 may be formed of magnetic or non-magnetic materials and is preferably configured to withstand typical operating pressures (system pressures) of 6,000 to 10,000 psi. For example, the tube 53 may be made of light-weight but strong materials such as titanium or carbon fiber or a composite of titanium and carbon fiber. The pressure vessel 52 of this embodiment has a cap 55 to seal the top end 56 of the tube 53, but alternatively, the tube 53 and closed top end 56 can be made from a solid, integral piece of material. The tube wall 54 is preferably as thin as possible, such as 0.31″ for 6,000 psi rated retriever, because the tube wall 54 is between outer magnetic core 64 and inner magnetic core 74 and the magnetic coupling forces between them varies according to the distance between them.

The interior and exterior surfaces of the tube wall 54 may have a low friction coating or sleeve, such as TEFLON® or similar protective coating, to reduce the frictional forces between the tube wall 54 and the inner rotor assembly 72 and outer drive assembly 62 during rotation and translation of the inner rotor assembly 72 and outer drive assembly 62 relative to the tube wall 54.

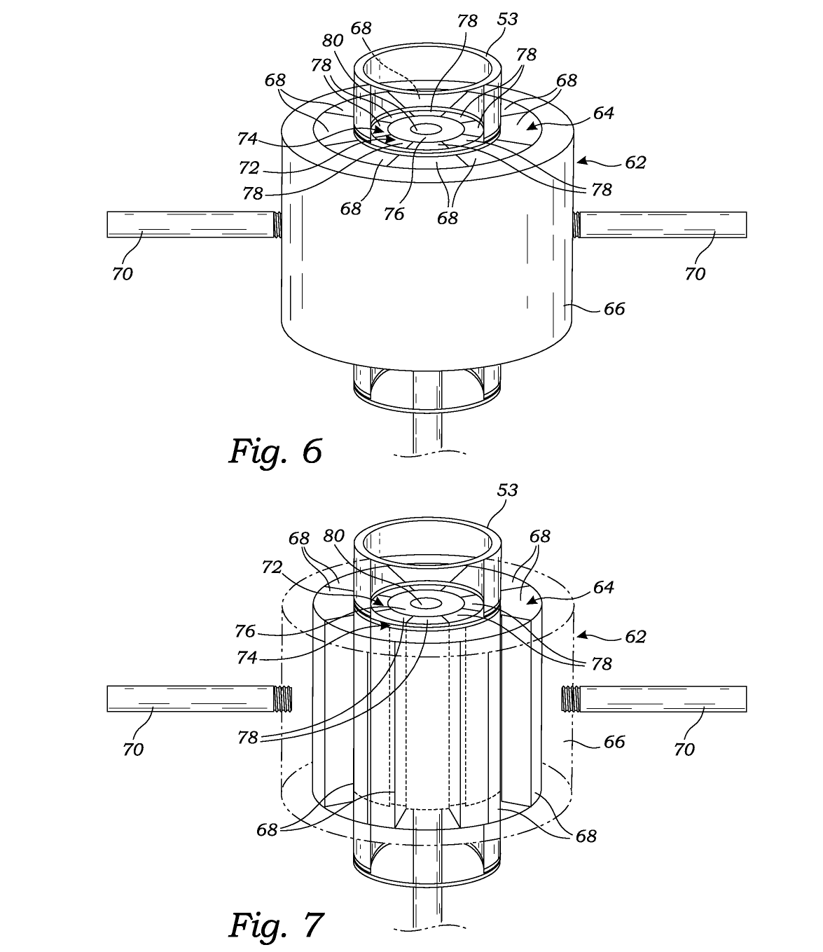

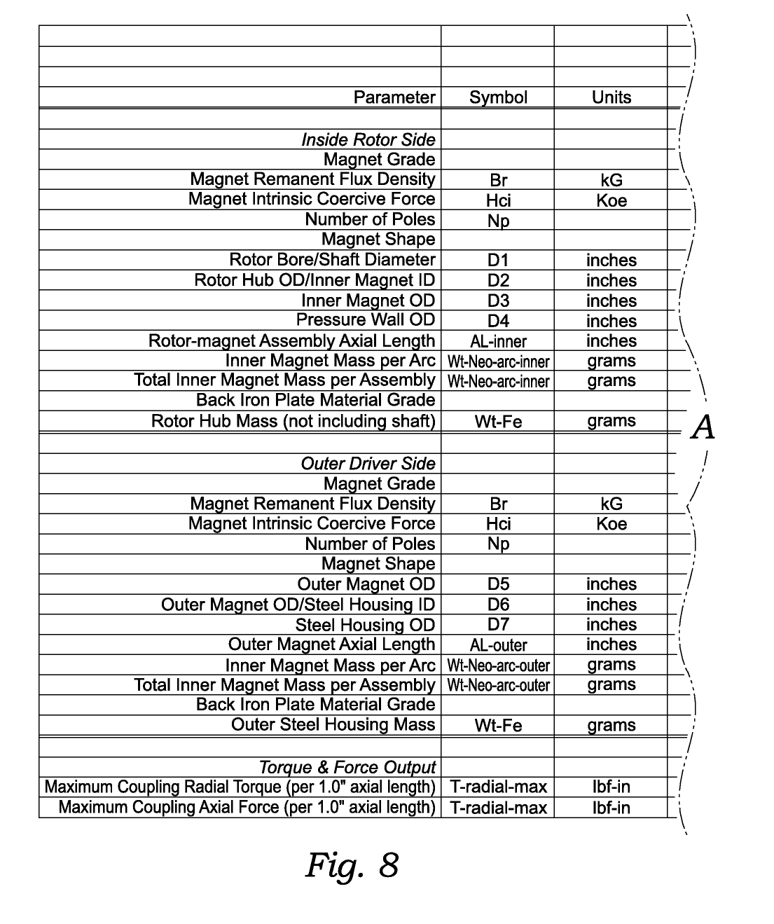

An outer drive assembly 62 is slidably mounted to the outer portion (exterior surface) of the tube 53 such that the outer drive assembly 62 can move both longitudinally along the longitudinal axis 57 of the tube 53, and rotationally about the longitudinal axis 57 of the tube 53. Turning to FIGS. 6 and 7, the outer drive assembly 62 comprises an outer magnetic core 64 mounted within a sleeve 66.

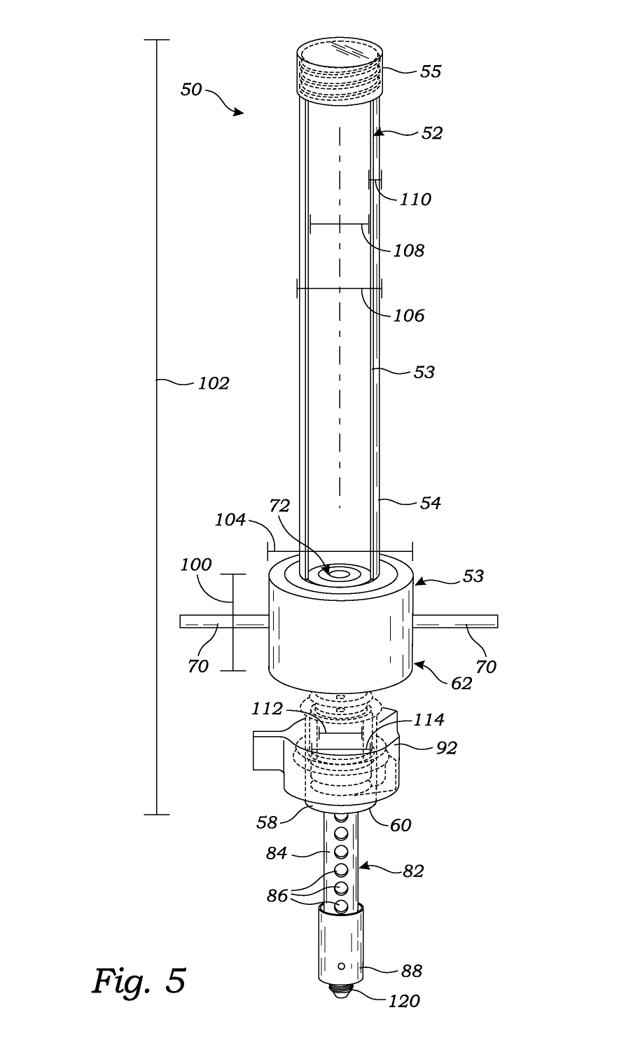

The outer magnetic core 64 comprises one or more outer core magnet(s) 68. In this exemplary embodiment, the outer magnetic core 64 has eight magnets 68. The magnets 68 are fixed to the sleeve 66, and are preferably permanent magnets. It should be understood that any suitable number of magnets 68 may be utilized, such as from 2 to 12 magnets 68, or from 8 to 12 magnets 68, or more. Each of the eight magnets 68 are in the shape of an annular sector of a cylinder such that the eight magnets 68 together form a cylinder (i.e. the magnets 68 have a cross-section in the shape of a sector of an annulus about the longitudinal axis 57). Each of the magnets 68 has a magnetic pole adjacent the exterior surface of the tube wall 54, either the North pole (N) or the South pole (S). In the illustrated embodiment, the magnets 68 are oriented with alternating magnetic poles adjacent the tube wall 54 (i.e. N, S, N, S . . . ). In other embodiments, the magnets 68 may be oriented with all similar poles (either N or S) adjacent the tube wall 54, or any other suitable arrangement, such as NN, SS, NN, SS . . . , etc. The outer magnetic core 64 and sleeve 66 each have an axial length 100 (see FIG. 5) in the direction of the longitudinal axis 57 (i.e. the length of the cylinder formed by the magnets 68). The inner diameter surface of the outer magnetic core 64 may be coated with a low friction coating or sleeve, such as TEFLON® or similar protective coating, to reduce the frictional forces between the tube wall 54 and the outer magnetic core 64 during rotation and translation of the outer drive assembly 62 relative to the tube wall 54.

The sleeve 66 may be cylindrical and can be formed of a high magnetic permeability material to complete and enhance the magnetic field coupling between the outer magnetic core 64 and inner magnetic core 74. For instance, the sleeve 66 may be made of carbon steel or other magnetic material base. The sleeve 66 also provides structure for coupling the outer drive assembly 62 to a drive system for manipulating the outer drive assembly to move it longitudinally and rotationally, such as one or more handles 70. Alternatively, the drive system coupled to the outer drive assembly 62 may be a motor, hydraulic, mechanical or pneumatic drive for local or remote operation. This may also allow for surface and sub-sea operation under extreme external pressures.

Still referring to FIGS. 4-7, the magnetic retrieval tool 50 further comprises an inner rotor assembly 72 disposed within the tube 53. The rotor assembly 72 also has a cylindrical shape, and comprises an inner magnetic core 74 mounted to the exterior surface of a support core 76. The inner magnetic core 74 comprises at least one inner core magnet 78, in this exemplary embodiment, eight magnets 78. The magnets 78 are fixed to the support core 76, and are preferably permanent magnets. The number of inner core magnets 78 will typically be the same as the number of outer core magnets 68, but it is also possible to use a different number of magnets 78 from the number of magnets 68. Again, it should be understood that any suitable number of magnets 78 may be utilized, such as from 2 to 12 magnets 78, or from 8 to 12 magnets 78, or more. Each of the eight magnets 78 are in the shape of an annular sector of a cylinder such that the eight magnets 78 together form a cylinder (i.e. the magnets 78 have a cross-section in the shape of a sector of an annulus about the longitudinal axis 57). Since the inner magnetic core 74 is disposed within the tube 53, the outer diameter of the cylinder formed by the inner magnetic core is smaller than the inner diameter of the cylinder formed by the outer magnetic core 64 by at least the thickness of the tube wall 54. Each of the magnets 78 has a magnetic pole adjacent the interior surface of the tube wall 54, either the North pole (N) or the South pole (S). In the illustrated embodiment, the magnets 78 are oriented with alternating magnetic poles adjacent the tube wall 54 (i.e. N, S, N, S . . . ). In other embodiments, the magnets 78 may be oriented with all similar poles (either N or S) adjacent the tube wall 54, or other desired arrangement, such as NN, SS, NN, SS . . . , etc. The inner magnetic core 74 and support core 76 each have an axial length 100 (see FIG. 5) in the direction of the longitudinal axis 57 (i.e. the length of the cylinder formed by the magnets 78). The outer diameter surface of the inner magnetic core 74 may be coated with a low friction coating or sleeve, such as TEFLON® or similar protective coating, to reduce the frictional forces between the tube wall 54 and the inner magnetic core 74 during rotation and translation of the inner rotor assembly 72 relative to the tube wall 54.

Like the sleeve 66, the support core 76 may be cylindrical and, can be formed of a high magnetic permeability material, such as carbon steel or other magnetic material base, to complete and enhance the magnetic field coupling between the outer magnetic core 64 and inner magnetic core 74. The support core 76 also has a pressure balance port 80 from the top end of the inner rotor assembly 72 to the bottom end of the inner rotor assembly 72, which allows pressure balancing within the tube 53 across the inner rotor assembly 72 (i.e. allows pressure to pass across the inner rotor assembly 72 within the interior of the tube 53). The pressure balance port 80 may be a hole as shown, or it can be a slot, multiple holes and/or slots, or other suitable fluid pathway across the support core 76.

A coupling mechanism 82 is attached to the bottom end of the inner rotor 72. The coupling mechanism 82 has an extension rod 84 which is attached to, and extends downward from, the bottom end of the support core 76. The extension rod 84 has a plurality of openings 86 and an interior lumen in fluid communication with the openings 86 and the pressure balance port 80. An end effector tool 88 is disposed on the bottom end of the extension rod 84. The end effector tool 88 is configured to engage and manipulate an access plug and/or device (such as a probe) within a pressurized system. As an example, the end effector tool 88 may have a socket head for engaging a square or hex head of an access plug. The tool 88 may also have a threaded plug retaining device 120, magnet or biasing device for retaining an access plug or probe once it has been disconnected.

The magnetic retrieval tool 50 also has an interface coupling 92 for attaching the magnetic retrieval tool 50 to a service valve 30 attached to an access fitting 12 of a pressurized system. The top end of the interface coupling 92 is attached to the bottom portion of the pressure vessel 52 (such as the bottom portion of the tube 53) in a fluid tight manner. The bottom end of the interface coupling 92 is configured to couple to a service valve 30 on an access fitting 12 of a pressurized system in order to couple the magnetic retrieval tool 50 to the access fitting. For instance, the interface coupling 92 may be a threaded, flanged, Grayloc, remotely operated coupling or similar means of attaching a retrieval tool to a service valve 30 on an access fitting 12 installed on a pressurized system. The interface coupling 92 has a lumen through which the extension rod 84 of the end effector tool 88 extends. The interface coupling 92 may also have integral or separate seal(s) where it attaches to a service valve to contain internal system pressure without leakage. The interface coupling 92 should be configured to provide proper positioning and coupling of the end effector tool 88 to the target plug or device to be retrieved or inserted in the pressurized system.

Turning to FIG. 5, some of the design dimensions for an exemplary magnetic retrieval tool 50 are shown. The axial length 102 from the bottom end of the interface coupling 92 to the top of the cap 55 may be about 33 inches, or longer. The axial length 100 of each of the outer magnetic core 64, sleeve 66, inner magnetic core 74 and support core 76 is about 4 inches. The outer diameter 104 of the sleeve 66 is about 5.5 inches. The outer diameter 106 of the tube 53 is about 3.12 inches. The inner diameter 108 of the tube 53 is about 2.5 inches. The thickness 110 of the tube wall 54 is about 0.31 inches for 6,000 psi rated retrieval tool 50. The inside diameter 112 of the interface coupling 92 at the connection to the pressure vessel 52 is about 1.8 inches. The inside diameter 114 of the interface coupling 92 where it attaches to a service valve or access fitting of a pressurized system is about 2.365 inches.

The operation and use of the magnetic retrieval tool 50 to retrieve a device, such as a probe, from a pressurized system, without depressurizing the system having an access fitting, will now be described. As discussed above, typically, the device is installed behind an access plug of an access fitting mounted on a pipe or vessel of the pressurized system. If the access fitting is not already fitted with a service valve, then a service valve 30 is first installed on the access fitting 12 providing a pressure tight seal between the access fitting, the service valve and the retrieval tool 50. The service valve 30 is open at this point, as the system pressure is sealed by the access plug 22 and seal 23.

Then, the magnetic retrieval tool 50 is installed on the service valve, by attaching the interface coupling 92 to the service valve. Depending on the type of interface coupling 82, this can be done by screwing the coupling 92, remotely operating the coupling 92, etc., to provide a pressure tight seal between the interface coupling 92 and the service valve. The service valve is open at this point, as the system pressure is sealed by the access plug.

The outer drive assembly 62 is actuated, by manually manipulating the handles 70 or operating a driver, to move the outer magnetic core 64 longitudinally downward toward the access plug. The longitudinal movement of the outer magnetic core 64 causes substantially simultaneous and corresponding longitudinal movement of the inner rotor assembly 72 and its inner magnetic core 74 downward, thereby moving the end effector tool 88 of the coupling mechanism 82 through the service valve and into engagement with the access plug.

The outer drive assembly 62 is then rotated thereby rotating the outer magnetic core 64 about the longitudinal axis 57 of the tube 53. The rotational movement of the outer magnetic core 64 causes substantially simultaneous and corresponding rotation of the inner magnetic core 74 and the inner rotor assembly 72, thereby rotating the end effector tool 88. The rotation of the end effector tool 88 unscrews the access plug from the access fitting. As the plug is partially unscrewed, the plug allows system pressure to pass the plug, pass through the openings 86 in the extension rod 84 and the lumen of the extension rod 84, then through the pressure balance port 80 and into the tube 53 of the magnetic retrieval tool 50, thereby pressurizing the tube 53 (and consequently the pressure vessel 52).

Once the tube 53 is pressurized to the system pressure, the outer drive assembly 62 is further rotated to completely remove the plug and also the device behind the plug. Once the plug and device are completely detached from the access fitting, the outer drive assembly 62 and outer magnetic core 64 are moved longitudinally away from the access fitting. The longitudinal movement of the outer magnetic core 64 causes substantially simultaneous and corresponding longitudinal movement of the inner magnetic core 74 and the inner rotor 72 thereby moving the end effector tool 88, plug and device out through the service valve and into the tube 53 of the magnetic retrieval tool 50.

The service valve 30 is then shut to seal the system process pressure from the magnetic retrieval tool 50. The tube 53 is de-pressurized, such as by partially removing the interface coupling 92 from the service valve to allow pressure to escape. The magnetic retrieval tool 50 is removed from the service valve by completely disconnecting the interface coupling 92 from the service valve 30. Finally, the access plug, and attached device may be removed from the end effector tool 88.

The procedure for using the magnetic retrieval tool 50 to insert a device, such as a probe, into a pressurized system is basically the reverse order of the procedure to retrieve a device. The device is attached to the access plug. The access plug and attached device are coupled to the end effector tool 88 of the magnetic retrieval device 50. If not already in place, a service valve is installed onto the access fitting providing a pressure tight seal between the access fitting and the service valve. If a plug is installed on the access fitting, then it is removed using the magnetic retrieval tool, as described above.

With the plug removed, and the service valve installed with the service valve closed at this point, the magnetic retrieval tool 50 is installed on the service valve by attaching the interface coupling 92 to the service valve to provide a pressure tight seal between the service valve and the interface coupling 92. The service valve bypass valve is opened to slowly pressurize the tube 53 to system pressure.

The service valve is then opened, such as fully opened, to allow the device and plug attached to the end effector 88 to be inserted through the service valve to the access fitting. The outer drive assembly 62 is actuated to move the outer magnetic core 64 longitudinally proximally toward the access fitting. The longitudinal movement of the outer magnetic core 64 causes substantially simultaneous and corresponding longitudinal movement of the inner rotor assembly 72 and its inner magnetic core 74 to move the end effector tool 88, plug and attached device through the service valve to the access fitting.

The outer drive assembly 62 is then manipulated to engage the access plug and device into the access fitting. Similar to the removal step described above, except in the opposite direction, the outer drive assembly 62 may be actuated to rotate the outer magnetic core 64 about the longitudinal axis 57 of the tube 53. The rotational movement of the outer magnetic core 64 causes substantially simultaneous and corresponding rotation of the inner rotor assembly 72 and its inner magnetic core 74 to rotate the end effector tool 88 and the attached access plug and device. The rotation of the end effector tool 88 screws the access plug into the access fitting. The outer drive assembly 62 is manipulated to tighten the access plug and device sufficiently to provide a seal of the system pressure.

The tube 53 is slowly de-pressurized, such as by partially removing the interface coupling 92 from the service valve to allow pressure to escape. Once the tube 53 is de-pressurized, the magnetic retrieval tool 50 is removed from the service valve by completely disconnecting the interface coupling 92 from the service valve. Then, if desired, the service valve may be removed from the access fitting.

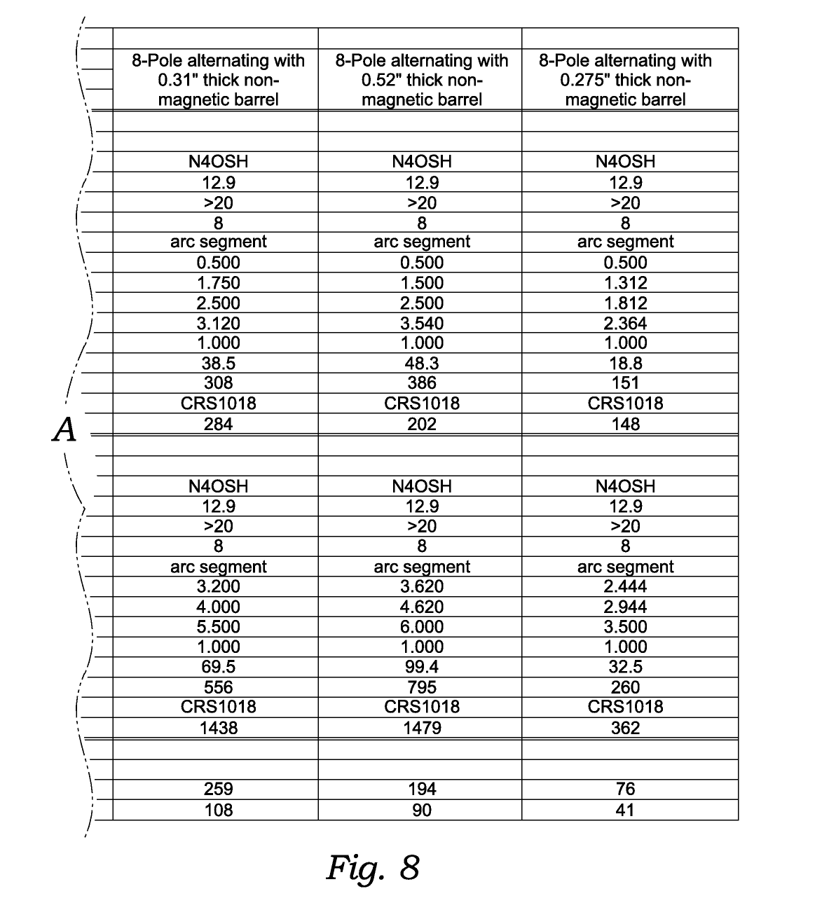

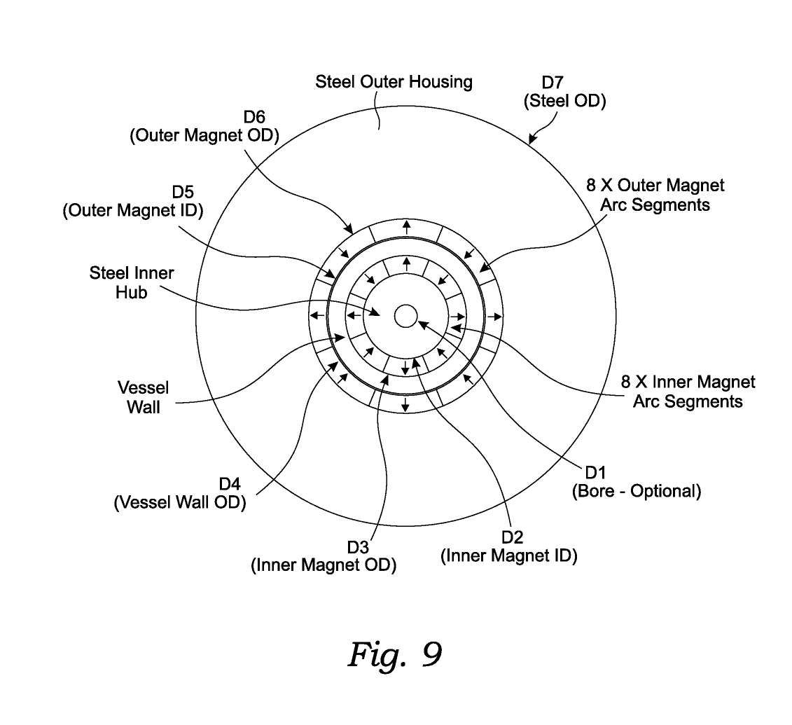

Turning now to FIGS. 8-10, an analysis of the magnetic force characteristics of several exemplary design configurations of the outer magnetic core 64, inner magnetic core 74, and pressure vessel 52 for a magnetic retrieval tool 50 will be discussed and compared. The magnetic force analysis was performed using finite element analysis. FIGS. 8 and 9 show the design characteristics for three different design configurations, which each have eight alternating pole magnets 68 in outer magnetic core and eight alternating pole magnets 78 in inner magnetic core 78, but differing magnet sizes (i.e. different inner diameter and outer diameter for the cylinder sector magnets 68 and 78), as shown in the table of FIG. 8 and the dimensional schematic of FIG. 9. Each of the designs has an axial length 100 of the outer magnetic core 64, sleeve 66, inner magnetic core 74 and support core 76 of 4 inches, and the other dimensions and properties as listed. Each of these designs is also configured for pressure ratings of from 6,000 psi to 10,000 psi. For this discussion, the design in column 4 of the table of FIG. 8 will be called Design 1, the design in column 5 of the table of FIG. 8 will be called Design 2, and the design in column 6 of the table of FIG. 8 will be called Design 3.

From the table of FIG. 8, it can be seen that Design 1 uses the largest magnets 68 and 78 of the three designs, and thus the largest outer magnetic core 64 and inner magnetic core 74, resulting in the heaviest design as well. Design 1 also provides the greatest maximum coupling radial torque per 1 inch of axial length (259 lbf-in), and the greatest maximum coupling axial force per 1 inch of axial length (108 lbf).

On the other hand, Design 3 has the smallest and lightest magnets 68 and 78 of the three designs, and the smallest outer magnetic core 64 and inner magnetic core 74, resulting in the lightest design as well. However, Design 3 has the lowest maximum coupling radial torque per 1 inch of axial length (76 lbf-in), and the lowest maximum coupling axial force per 1 inch of axial length (41 lbf).

Design 2 is somewhere between Design 1 and Design 3 in weight, size and maximum coupling radial torque per 1 inch of axial length (194 lbf-in), and maximum coupling axial force per 1 inch of axial length (90 lbf).

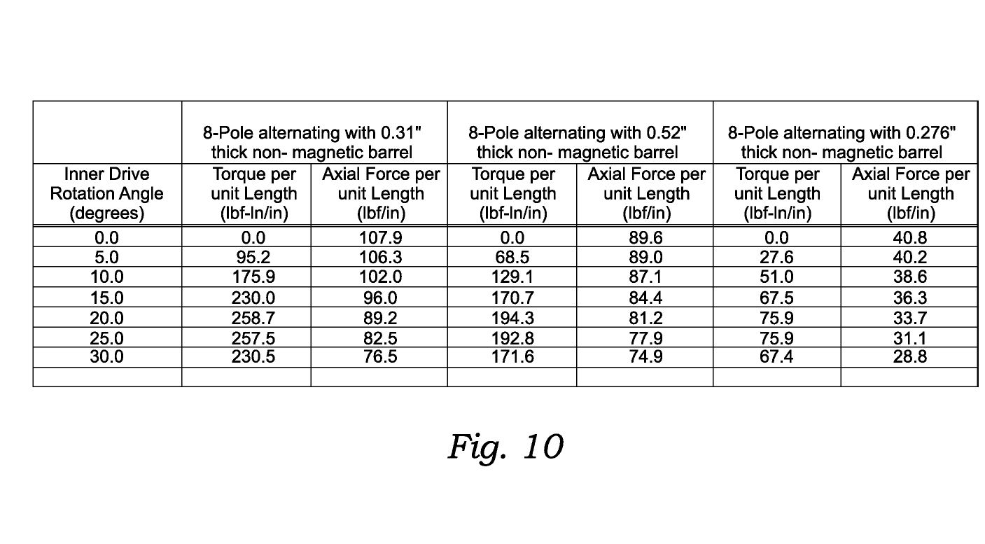

Referring now to FIG. 10, the table shows the torque per unit axial length 100 and axial force per unit axial length 100 of the outer magnetic core 64 and inner magnetic core 74 for Designs 1, 2 and 3 for different rotational slip angles (offset) between the outer magnetic core 64 and inner magnetic core 74. The table shows the torque and axial force for offsets from 0.0 degrees to 30.0 degrees. It can be seen that the maximum torque per unit axial length 100 is generated at an offset of about 20-25 degrees, and the maximum axial force per unit axial length 100 is generated at an offset of 0.0 degrees.

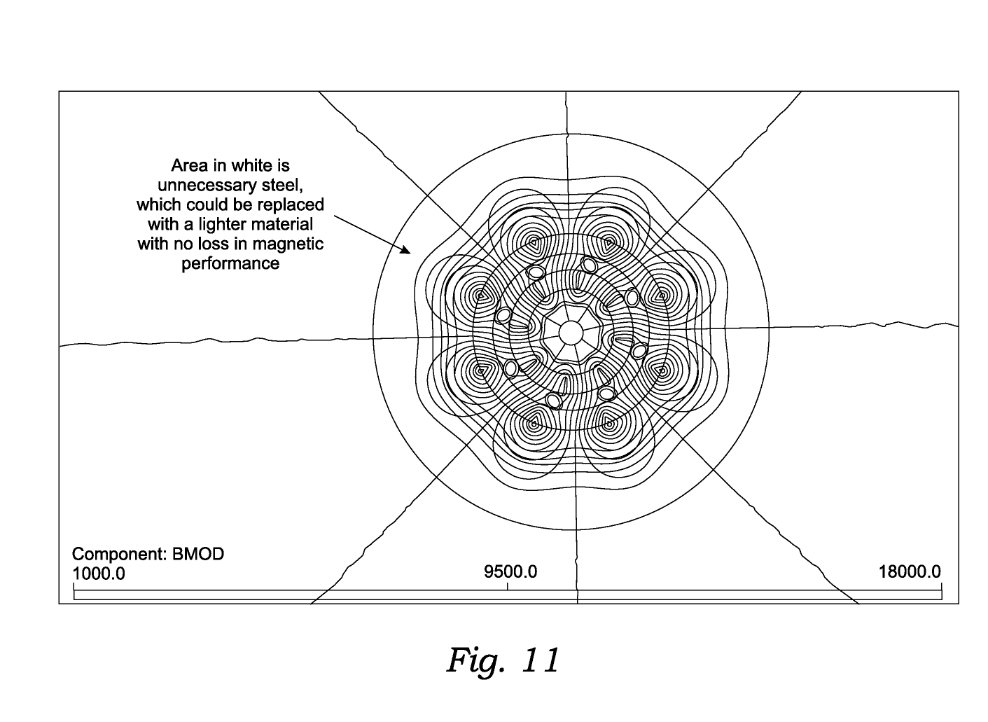

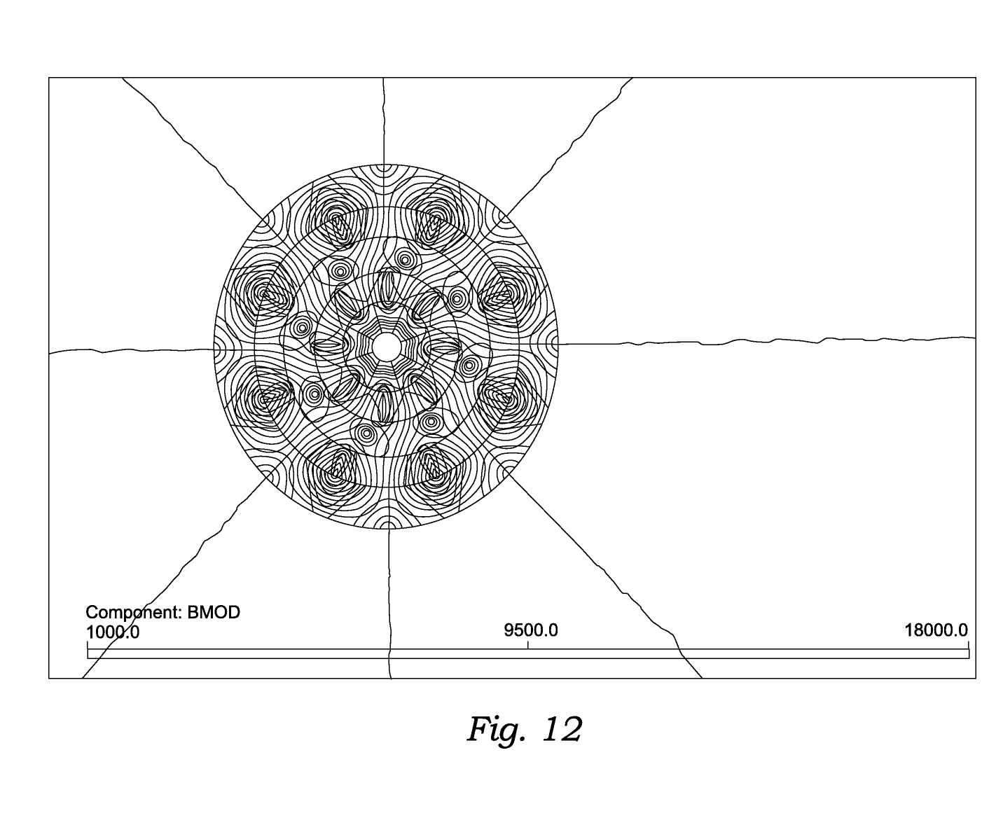

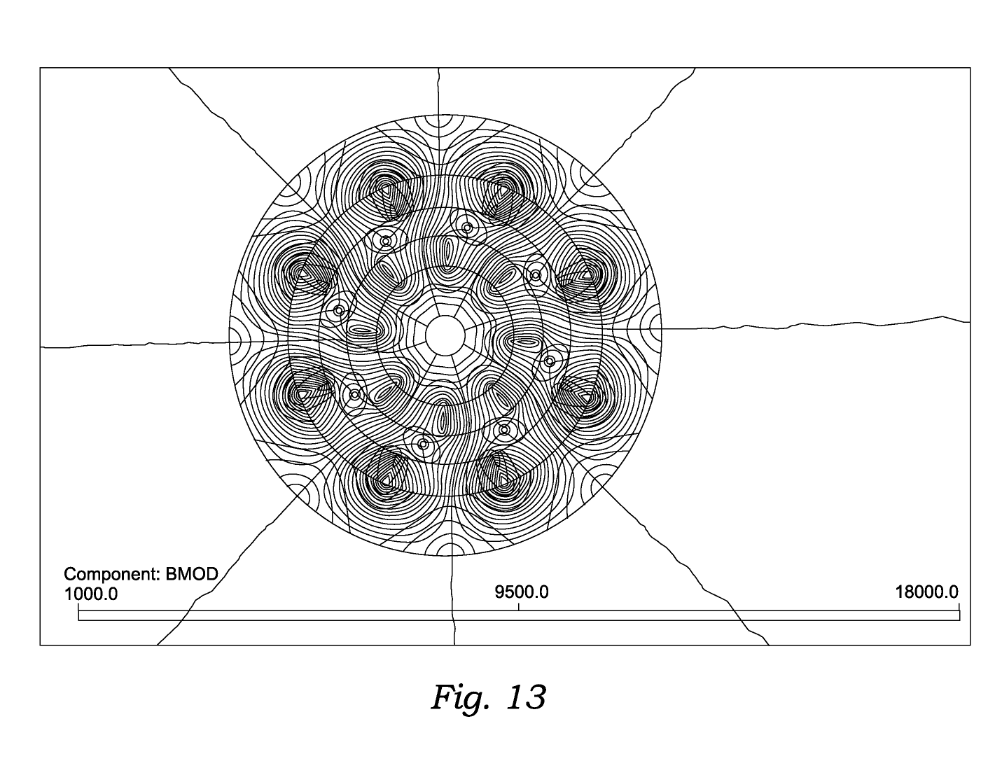

FIGS. 11, 12 and 13 show corresponding magnetic flux plots with different outer magnetic core diameters in order to consider configurations with lower weight from smaller diameter. The computations in the flux plots are shown per 1 inch of axial length of magnetic core. Typical designs may use an axial length 100 of approximately 4 inches to suit most applications. Of course, larger torque and axial force can be produced by using longer axial lengths and larger diameters of the magnetic cores, as required.

Although particular embodiments have been shown and described, it is to be understood that the above description is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims. For example, not all of the components described in the embodiments are necessary, and the invention may include any suitable combinations of the described components, and the general shapes and relative sizes of the components of the invention may be modified. Accordingly, embodiments are intended to exemplify alternatives, modifications, and equivalents that may fall within the scope of the claims. The invention, therefore, should not be limited, except to the following claims, and their equivalents.

1. A magnetic retrieval tool comprising:
a pressure vessel;
an outer drive assembly mounted to an outer portion of the pressure vessel in a manner to allow movement of the outer drive assembly longitudinally along a longitudinal axis of the pressure vessel, and rotationally about the longitudinal axis of the pressure vessel; and
an inner rotor within an inner portion of the pressure vessel, magnetically coupled to the outer drive assembly in a manner such that movement of the outer drive assembly causes substantially simultaneous and corresponding movement of the inner rotor;
wherein the outer drive assembly comprises an outer magnetic core mounted within a sleeve, the outer magnetic core comprising a plurality of magnets having alternating magnetic poles, and the sleeve comprising an actuation mechanism; and
wherein the inner rotor comprises an inner magnetic core mounted to a support core, the inner magnetic core comprising a plurality of magnets having alternating magnetic poles.

2. The magnetic retrieval tool of claim 1, wherein the pressure vessel is a tube having a closed top end.

3. The magnetic retrieval tool of claim 1, wherein the sleeve and the support core each comprise carbon steel.

4. The magnetic retrieval tool of claim 1, wherein the actuation mechanism comprises a handle.

5. The magnetic retrieval tool of claim 1, wherein the plurality of magnets of the inner magnetic core comprise between 2 and 12 magnets, and the plurality of magnets of the outer magnetic core comprise between 2 and 12 corresponding magnets.

6. The magnetic retrieval tool of claim 1, wherein the pressure vessel comprises non-magnetic material.

7. The magnetic retrieval tool of claim 1, configured to insert and/or remove probes, coupons or similar assemblies through a valve, into and/or out of an access fitting under pressure within a system, without shutting down the system.

8. A magnetic retrieval tool comprising:
a pressure vessel;
an outer drive assembly mounted to an outer portion of the pressure vessel in a manner to allow movement of the outer drive assembly longitudinally along a longitudinal axis of the pressure vessel, and rotationally about the longitudinal axis of the pressure vessel; and
an inner rotor within an inner portion of the pressure vessel, magnetically coupled to the outer drive assembly in a manner such that movement of the outer drive assembly causes substantially simultaneous and corresponding movement of the inner rotor;
wherein the outer drive assembly comprises an outer magnetic core mounted within a sleeve, the outer magnetic core comprising a plurality of magnets having all similar poles on an inner side of the outer magnetic core and all similar poles on an outer side of the outer magnetic core; and
wherein the inner rotor comprises an inner magnetic core mounted to a support core, the inner magnetic core comprising a plurality of magnets having all similar poles on an inner side of the inner magnetic core and all similar poles on an outer side of the inner magnetic core, wherein the pole are opposite the poles on the plurality of magnets of the outer magnetic core.

9. The magnetic retrieval tool of claim 8, wherein the pressure vessel is a tube having a closed top end.

10. The magnetic retrieval tool of claim 8, wherein the sleeve and the support core each comprise carbon steel.

11. The magnetic retrieval tool of claim 8, wherein the actuation mechanism comprises a handle.

12. The magnetic retrieval tool of claim 8, wherein the plurality of magnets of the inner magnetic core comprise between 8 and 12 magnets, and the plurality of magnets of the outer magnetic core comprise between 8 and 12 corresponding magnets.

13. The magnetic retrieval tool of claim 8, wherein the pressure vessel comprises non-magnetic material.

14. The magnetic retrieval tool of claim 8, configured to insert and/or remove probes, coupons or similar assemblies through a valve, into and/or out of an access fitting under pressure within a system, without shutting down the system.

15. A method of retrieving a device through a service valve into an access fitting under pressure within a system, using the retrieval tool of claim 1, comprising the steps of:
a. providing a pressure tight seal between the access fitting and the service valve;
b. providing a pressure tight seal between the service valve and the retrieval tool;
c. actuating the outer drive assembly causing movement thereof which in turn causes substantially simultaneous and corresponding movement of the inner rotor so as to pass an end effector tool of the inner rotor through the service valve to engage a plug of the access fitting;
d. manipulating the retrieval tool to initially allow process pressure slowly past the plug to pressurize the pressure vessel of the retrieval tool to a desired system pressure;
e. after the pressure vessel is pressurized to the desired system pressure, further manipulating the retriever to completely remove the plug and device from the access fitting;
f. manipulating the retrieval tool in a translational direction relative to the longitudinal axis of the pressure vessel to retrieve the device;
g. closing the service valve to seal the system pressure from the retrieval tool;
h. de-pressurizing the pressure vessel;
i. removing the retrieval tool from an isolating service valve; and
j. removing the plug and its attached device from the end effector tool.

16. A method of inserting a device through a service valve into an access fitting under pressure within a system, using the retrieval tool of claim 1, comprising the steps of:
a. attaching the device to a plug of the access fitting to be installed;
b. attaching the access plug and device to an end effector tool coupled to the inner rotor;
c. providing a pressure tight seal between the service valve and the retrieval tool;
d. opening a port of the service valve to slowly pressurize the pressure vessel of the retrieval tool to the system pressure;
e. opening the service valve to allow the device and plug attached to the end effector tool through the service valve;
f. actuating the outer drive assembly, causing movement thereof which in turn causes substantially simultaneous and corresponding movement of the inner rotor so as to pass the device and access fitting plug attached to the end effector tool down through the service valve to the access fitting;
g. manipulating the outer drive assembly to cause the inner rotor to substantially simultaneously correspondingly move to insert the plug and device into the access fitting;
h. manipulating the outer drive assembly to cause the inner rotor to substantially simultaneously correspondingly rotate to tighten the plug and device into the access fitting sufficient to seal against the system pressure;
i. de-pressurizing the retrieval tool; and
j. removing the retrieval tool from the service valve

17. The method of claim 16, further comprising the step of:
k. after step j., removing the service valve.
